(19) United States
(12) Patent Application Publication
(10) Pub. No.: US 2009/0212961 A1
(43) Pub. Date: Aug. 27, 2009

(54) Wireless remote controllable fire and smoke alarm system

(76) Inventor: Simon McGivern, London (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/884,512

(22) PCT Filed: Feb. 17, 2006
(86) PCT No.: PCT/GB06/00563

§ 371 Date: Nov. 17, 2008

(30) Foreign Application Priority Data
Feb. 18, 2005 (GB) 0503452.5
Sep. 22, 2005 (GB) 0519373.5
Dec. 12, 2005 (GB) 0525247.3

(51) Int. Cl. G08B 17/10

(52) U.S. Cl. 340/628

(57) ABSTRACT

The invention relates to a system with base units 10 and smoke alarms 50. The base units are plug in base units 10 that have a plug 14, 16 that may plug into and be supported by a conventional mains power socket 18. Simple broadcast messages provide test, mute and panic alarm functionality.

The present invention relates to smoke alarm systems and more particularly to a wireless fire and smoke alarm system.

The need for cost-effective security systems, which permit simple installation without the need for hard wiring, has led to the development of many so-called wireless alarm systems. However, many of these systems still require a hardwired keypad, a base station, a hardwired siren and power connections, maintaining the need for skilled installers and considerable wiring. Accordingly, the market potential of wireless fire and security systems has not been realised.

A wireless home system which utilises two-way transceivers in the smoke detectors, other sensors and the base station was proposed by Marman et al. in U.S. Pat. No. 6,624,750. Marman et al. proposes the elimination of the hardwired keypad and siren by incorporating a test/mute button and siren into every smoke alarm. Power wiring is eliminated because the base station and sensors are both battery powered. Low battery conditions in sensors are communicated to the base station which may be situated, for example, in a building manager's office, rather than simply causing an annoying sound which may cause users to remove the batteries completely.

Current alarm systems whether wired or wireless are inherently sensitive. Consequently, there may often be a large number of false alarms, each of which requires the user to reset/mute the alarm signal. As a result, when irritation is caused by constant interruptions for false alarms, the very people they are there to protect often disable the alarms.

### SUMMARY OF THE INVENTION

According to the invention there is provided a smoke alarm system, comprising:
a plurality of units including at least one smoke alarm and at least one base station;
wherein the or each base station includes:
a transmitter within the housing for transmitting to the at least one smoke alarm;
means for causing the transmitter to transmit a learn signal including a serial number of the base station; and
means for causing the transmitter to transmit a test signal including the serial number;
wherein the or each smoke alarm includes:
a battery,
a sounder for sounding an alarm;
a receiver for receiving signals transmitted from the base station or stations;
a test button arranged to operate the smoke alarm to sound when the test button is actuated;
a learn button arranged to cause the smoke alarm to enter a learn mode when the button is pressed and in the learn mode to listen for a learn signal on the receiver, and to store the serial number transmitted in the learn signal when the smoke alarm receives a learn signal when in the learn mode; and
a smoke detector for sounding an alarm when exposed to smoke.

In this way, communications between base station and smoke alarm can be carried out very easily and without difficulty. The base station can control a number of units. Unlike in Marman, where complex two way communication is required to “enrol” a new device, the invention makes it possible to simply add a new smoke alarm in a simple manner which in turn permits the device to have minimal complexity. In particular, the approach is able to operate with messages transmitted only from base station to smoke detector, instead of multiple two way messages as required by Marman.

Preferably, the base station unit is a plug in unit. By providing a “plug-in” base station unit, i.e. a unit which is made up simply of a housing, with pins coming out of the housing, the unit may be supported by a conventional mains socket.

In this way, a simple convenient unit is provided that may be positioned by the user where required without the need for wiring. The central unit, being mains powered, does not require batteries, though in preferred embodiments rechargeable batteries are provided to allow the unit to operate in the event of a failure of mains power, which may for example occur during a fire.

In particular, such a unit may be conveniently positioned in the user's kitchen, which is often the location for false smoke alarms, at a position close to the hob or oven. In the event of a smoke alarm sounding, the smoke alarm may be conveniently controlled from the base unit.

Smoke alarms must be mounted either on the ceiling or typically within 15 cm of it, so they are frequently not within convenient reach. Therefore, users may need to stand on a support, for example a chair, to reach the smoke alarm. This can be conveniently avoided by simply plugging in a base unit at a lower level in a convenient location, for example within the kitchen.

The base station may further include a panic button arranged to cause the base station to transmit a panic message to the other units to cause the other units to sound an alarm when the panic button is operated. The invention thus adds the functionality of a panic alarm simply by using existing smoke detectors. The panic alarm can conveniently be located and moved by the user simply by plugging the base station into a convenient location.

The units may each include a system address value unit setting a system address value in common for the system, the units being arranged to broadcast messages including the system address value and a message type value, the message type value indicating one of a plurality of messages including a smoke alarm mute message, a test message, and a smoke alarm message, the messages being broadcast to all other units of the system.

This simple protocol using messages that may be very short simplifies the system.

Preferred embodiments of the base station include a test/mute control, arranged to broadcast a message to all smoke alarms of the system on operation of the test control to mute the smoke alarms if any of the smoke alarms of the system are active and otherwise to test the smoke alarms of the system.

By using a broadcast message approach the system does not require complex protocols for communication between the base station and individual detectors.

The smoke alarm unit may be arranged to transmit a battery low message when a low battery condition is present in the respective smoke alarm; and the base unit is arranged to sound an audible warning sound when it receives a battery low message.

A particular benefit of the invention is that it can work with multiple base stations. The base stations do not need to be separately programmed but each can simply be plugged in.

In another aspect, the invention provides a base station for use in a smoke alarm system including at least one smoke alarm including a battery, a smoke detector, a sounder, and a transmitter and receiver, the base station comprising:
a housing;
a receiver within the housing for communicating with the at least one smoke alarm;
a plurality of pins extending from the housing, the pins and housing cooperating to define a unitary plug for connection to an electrical supply socket, so that the base station is supported by the pins when the plug is inserted into an electrical supply socket.

The base station may further include a rechargeable battery pack.

The invention also relates to a method of operating a smoke alarm system including a plurality of smoke alarm units, comprising:

plugging at least one base unit into a respective electrical power socket to be supported by the socket; and
controlling the smoke alarm units by silencing any sounding smoke alarms of the system when a control on the base unit is actuated; and
testing the smoke alarm system when the control on the base unit is actuated.

For a better understanding of the invention, embodiments will now be described, purely by way of example, with reference to the accompanying drawings, in which:

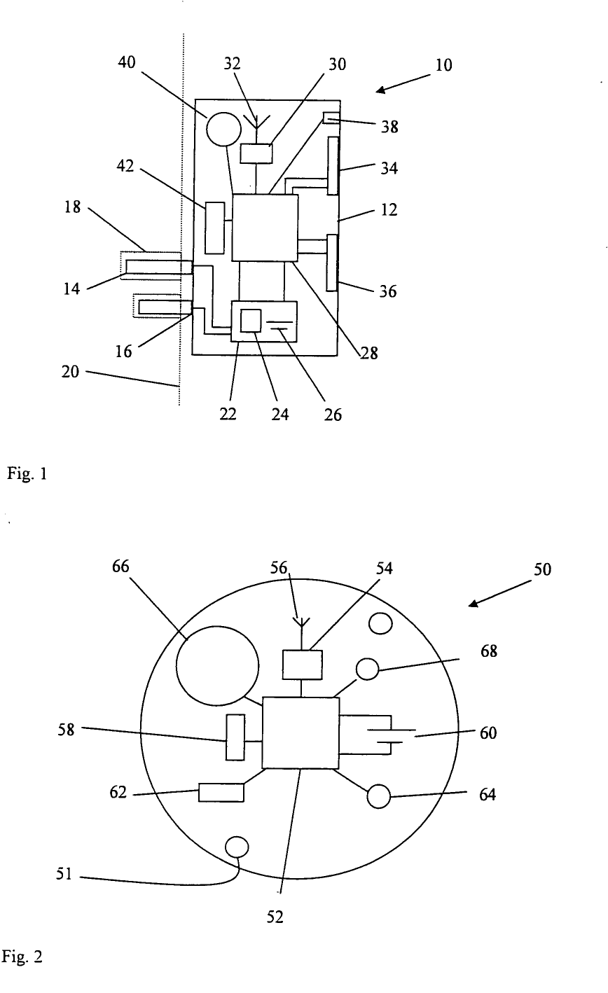

FIG. 1 shows a schematic drawing of a base station of an embodiment of the invention;

FIG. 2 is a schematic of a smoke alarm unit;

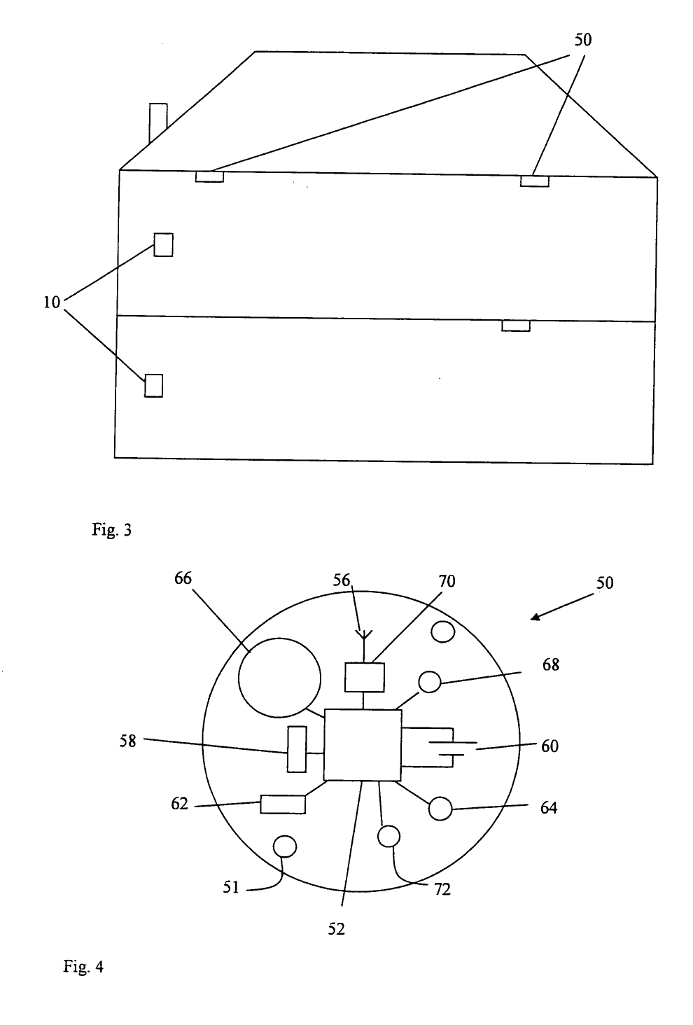

FIG. 3 shows a schematic drawing of a system including a base station and a number of smoke alarm units; and

FIG. 4 illustrates a schematic of a smoke alarm unit according to an alternative embodiment of the invention.

Referring to FIG. 1, a base station 10 according to the invention includes a housing 12 and a plurality of pins 14 extending from the housing in a plug region 16 of the housing. The embodiment of FIG. 1 is intended to mate with a UK standard electrical power socket 18, shown dotted, in wall 20, and so the pins 14 are arranged as a standard UK power plug. The skilled person will realise that, in other countries, other standards of electrical power socket exists, and will appreciate that the pins may be arranged accordingly. In some electrical standards, support is not just provided by pins 14 but by the shape of the housing in plug region 16, and accordingly the plug region 16 may be suitably shaped, for example to fit into a recessed power socket.

The size of the base station 10 is little bigger than a conventional plug, perhaps no more than 10 cm high, 5 cm thick and 5 cm wide, and may preferably be a little smaller. Thus, the base station 10 can be supported simply by pins 14 and plug region 16. This allows the user to locate the base station 10 in any room where required simply by inserting the base station 10 into a suitable free electrical socket. The base station may thus be referred to as a “plug-in” base station.

The base station 10 also includes a power module 22 including a rectifier 24 for delivering a dc output voltage from that supplied from the mains on mains socket 18, and a battery back up 26. The batteries may be rechargeable batteries charged by the output of rectifier 24 when the base station 10 is connected to the mains supply.

A microprocessor-based controller 28 provides the central control unit within the base station. The base station also includes radio transceiver 30 connected to aerial 32. User operable controls in the form of a test/mute button 34 and a panic button 36 are both mounted on the housing 12, as is an LED indicator light 38. A sounder 40 is also provided within the housing.

Finally, a system address selector 42 is provided determining the system address, to avoid confusion with other installations. The system address selector may be, for example, a small DIP switch with multiple switches that may be used to specify an binary address in the range 0-15.

Referring to FIG. 2, a smoke alarm 50 includes a microprocessor controller 52, a transceiver 54, and aerial 56. A system address selector 58 is used to select the system address of the smoke alarm. The smoke alarm 50 is powered by a replaceable battery 60. A smoke detector 62, test/mute button 64, sounder 66 and LED 68 complete the smoke alarm 50. The test/mute button is mounted on the front face of the smoke alarm for accessibility. A mounting means 51, for example a through hole for a screw, permits the smoke alarm to be mounted with its rear face against a surface, typically a ceiling.

Referring to FIG. 3, a plurality of smoke alarm units 50 are mounted in various rooms with the rear face against the ceiling and the front face exposed. At least one base station 10 is provided. The address selector 42,58 of all the smoke alarms and the base station are set to the same address.

The microprocessors 28,52 are programmed using code included in the smoke alarm 50 and base unit 10 to carry out the following functions in use.

Firstly, in the event that a smoke alarm detects smoke, the unit detecting smoke sounds an aural “evacuate” alarm (a loud alarm) and an LED signal. It then transmits a message to other smoke alarms and the base unit of the system, which all sound an alert, a less intense sound than the “evacuate” alarm.

If the test/mute control is operated on the base unit 10, all smoke alarms 50 are deactivated. If the test/mute control is operated on the smoke alarm unit that detected smoke, that unit deactivates. If no additional units detected smoke, the whole system resets.

If no test/mute control is operated, then after a delay, for example of 2 minutes, all smoke alarms of the system sound the loud “evacuate” alarm. In this stage, the system can be reset by pressing the test/mute control on the base unit 10.

The second functionality offered by the system is the “test” functionality.

The test/mute control on the base station 10 is selected. This transmits a message to all smoke alarms 50, which give a quiet aural indication and LED signal except for faulty units which give a local “fault” indication, either with a louder aural tone, a different LED signal or other clear indication.

The user may then briefly operate the test/mute control 10 on the base station, at which time all smoke alarms 50 that were not faulty are reset, leaving only faulty units sounding.

Alternatively, the user may operate the test/mute control 10 for a longer period, at which point all smoke alarm units 50 operate the loud “evacuate” alarm, to test the full functionality of the system. To stop the loud alarm, the test/mute control 10 is operated again which resets all non-faulty smoke alarm units 50 leaving only faulty units sounding.

The system has a third functionality of detecting a low battery condition.

The local smoke alarm unit 50 detects that its battery is running low, and gives a local aural and LED warning. A fault message is transmitted to the base unit 10 and a system fault is indicated. After the fault has been corrected, and the batteries replaced, the fault indication clears.

The local smoke alarm unit 50 can also detect other fault conditions and report them in the same way. For example, the microprocessor self-test may detect a fault on start up. Alternatively, the unit may determine that the detector needs cleaning. In these cases, a fault message is again transmitted to the base unit.

The final functionality occurs when the panic button 36 on the base unit 10 is actuated. If this is operated, all smoke alarms 50 and the base unit 10 sounds the loud “evacuate” (SOS/Mayday) sound until the system is reset using the “test/mute” button 34 on the base unit 10.

The various alarm tones sounded may be those defined in international standards. ISO 8201 defines a suitable “evacuate” alarm tone and ISO 7731 defines a suitable “Alert” alarm tone.

Messages may be sent in a format, for example using a carrier sense multiple access (CSMA) protocol to allow collision free multiple transmissions. The packets may be in the following format:

a preamble (7 bits);
the system address value (4 bits) value 0 to 15;
the message type (4 bits); and
a parity bit (1 bit).

The message type may have the following values 1—“panic”; 2—“cancel panic” 3-“smoke alarm” 4 “smoke alarm mute” 5—“fault” 6—“quiet test” 7—“loud test”. The “cancel panic” and “smoke alarm mute” thus both operate as “silence” messages to prevent the sounders sounding.

The values 8-15 are initially undefined and allow for other messages to be transmitted if required. For example, in alternative embodiments they may allow the type of fault to be transmitted.

Note that the messages are very short—a total of 16 bits in the embodiment, preferably no more than 64 bits or, even further preferably, no more than 32 bits.

It will be seen that the very short messages provide all of the functionality required, since all of the messages can essentially be broadcast to all of the units in the same system. All units in the system share a system address which should be chosen to be different to that of other systems in the same locality. Thus, complex handshaking protocols to set up communications channels between the base unit 10 and individual smoke alarms are avoided, greatly reducing the communications load. Instead, a simple listen-first anti-collision approach is adopted. In this approach, a unit wishing to transmit first checks that no other system is transmitting before transmitting.

A further benefit of the system is that the base unit 10 and smoke alarm 50 have a very similar functionality, with the panic button of the base unit replacing the smoke detector of the smoke alarm. For this reason, the system operates with more than one base unit without any change. Thus, if a user requires to be able to cancel the smoke alarm from multiple locations, the user simply installs multiple base units by plugging in base units 10 wherever required.

The skilled person will appreciate that in other embodiments the panic button may be eliminated.

The system described above operates on a two level approach in which an initial alert is escalated to a full evacuate alarm if the alarm is not cancelled. The skilled person will realise that this is not essential and in an alternative approach all units simply sound a full evacuate alarm when smoke is detected.

Other features may be included if required. The circuitry can be battery saving, reverting to standby mode except when signals are received.

In a second embodiment of the invention, the system is as described above with a number of differences. In particular, the base station includes only a transmitter and the smoke alarms include only receivers 70 (FIG. 4) instead of transceivers 54 (FIG. 2). Each base station has a build in serial number. There are a large number of possible serial numbers, preferably at least 64 000, to ensure that there is a negligible risk of two base stations with the same number. This reduces the risk of possible interference between two different base stations to a very low number.

The smoke alarm in this embodiment further includes a “learn” button 72 which is mounted on the rear of the smoke alarm on the opposite side from the test-mute button, so that when the smoke alarm is mounted to a ceiling the learn button is not accessible. When the learn button is depressed, the smoke alarm enters a learn mode in which it listens for signals from base units 10. The base unit 10 is arranged to be able to transmit a learn signal or an unlearn signal.

When the smoke alarm 10 receives a learn signal it records the serial number of the base unit to register the smoke alarm to the base unit so that it only responds to that base unit. The unlearn signal clears the serial number of the base unit so that the smoke alarm can once again respond to any base unit.

In this way the smoke alarm can be set up to respond to only one or more preprogrammed base unit.

In the preferred embodiment, the smoke alarms are instead able to learn multiple base unit number thus allowing them to be controlled by multiple controllers.

In this embodiment, the base station has separate “test” and “mute” buttons 34 36. The test button 34 operates a system test and the mute button 36 mutes all units.

In this embodiment there is no separate panic button. Instead, the alarm is sounded if the test and mute buttons 34, 36 are pressed in the correct sequence.

The panic alarm can only be cancelled by individually muting the smoke alarms with their own test/mute buttons.

To allow the base unit 10 to operate the learn and unlearn mode without requiring additional buttons, the base unit is arranged to enter a learn mode and transmit a learn signal when plugged into mains power with the test button held down. The base unit is arranged to enter the unlearn mode and transmit an unlearn signal when the base unit is plugged into the mains with the mute button held down.

A further feature is that the base unit transmits an extra digit each time it is caused to transmit a learn signal. The first time, it transmits the digit “1”, the second time “2”, the third time “3” and so on up to “7”. The digit in the embodiment cycles again after 7, though this limit can of course be varied if required.

The point of the digit is to identify the sequence in which the smoke alarms are learnt. When the test button is pressed on the base unit, the base unit transmits its serial number plus each extra digit in turn. In this way, the smoke alarms sound in the same order in which they were programmed with the base unit number. In the embodiment, each digit sounds in turn for 5 seconds. This enables a tester to follow the smoke alarms round a building.

The smoke alarms are arranged to be able to receive from more than one base unit by enabling them to record more than one base station. This allows for multiple controllers.

Although in the above embodiment the learn button is inaccessible this is in no way an essential feature and accessible learn buttons may be provided if required.

The general features of the devices described are as required by, and in conformance with, the applicable national and or international standards for smoke alarms (e.g. ISO 12239, EN 54, BS 5446 etc).

1. A smoke alarm system, comprising:
a plurality of units including at least one smoke alarm and at least one base station;
wherein the or each base station includes:
a transmitter within the housing for transmitting to the at least one smoke alarm;
means for causing the transmitter to transit a learn signal including a serial number of the base station; and
means for causing the transmitter to transmit a test signal including the serial number,
wherein the or each smoke alarm includes:
a battery,
a sounder for sounding an alarm;
a receiver for receiving signals transmitted from the base station or stations;
a test button arranged to operate the smoke alarm to sound when the test button is actuated;
a learn button arranged to cause the smoke alarm to enter a learn mode when the button is pressed and in the learn mode to listen for a learn signal on the receiver, and to store the serial number transmitted in the learn signal when the smoke alarm receives a learn signal when in the learn mode; and
a smoke detector for sounding an alarm when exposed to smoke.

2. A smoke alarm system according to claim 1 wherein the base station includes:
a housing; and
a plurality of pins extending from the housing, the pins and housing cooperating to define a unitary plug for connection to an electrical supply socket, so that the base station is supported by the pins when the plug is inserted into an electrical supply socket.

3. A smoke alarm system according to claim 2 wherein the means for causing the base station transmitter to transmit a learn signal includes a user-operable control wherein the base station is arranged to transmit the learn signal when the button is depressed as the base station is inserted to the electrical supply socket.

4. A smoke alarm system according to claim 3 further comprising a user-operable control, wherein the base station is arranged to transmit an unlearn signal when the button is depressed as the base station is inserted to the electrical supply socket to erase the serial number transmitted in the unlearn signal when the smoke alarm receives an unlearn signal.

5. A system according to any preceding claim wherein the base station further includes a means for causing the base station to transmit a panic message to the other units to cause the other units to sound an alarm when the panic button is operated.

6. A smoke alarm system according to any of claims 1 to 5 wherein the means for causing the base station to transmit a test signal is a test/mute control, arranged to broadcast a message to all smoke alarms of the system on operation of the test control to mute the smoke alarms if any of the smoke alarms of the system are active and otherwise to test the smoke alarms of the system.

7. A smoke alarm system according to any of claims 1 to 5 wherein means for causing the base station to transit a test signal is a test control and the base station further includes a mute control, wherein the base station is arranged:
to broadcast a message to all smoke alarms of the system on operation of the test control to test the smoke alarms of the system;
to broadcast a message to all smoke alarms of the system on operation of the mute control to mute the smoke alarms; and
on operation of the test and mute controls in the correct predetermined sequence to cause the base station to transmit a panic message to the other units to cause the other units to sound an alarm.

8. A smoke alarm system according to any preceding claim including a plurality of like base stations each including a housing; a transmitter within the housing for communicating with the at least one smoke alarm; and a plurality of pins extending from the housing, the pins and housing cooperating to define a unitary plug for connection to an electrical supply socket, so that the base station is supported by the pins when the plug is inserted into an electrical supply socket.

9. A base station for use in a smoke alarm system including at least one smoke alarm including a battery, a smoke alarm, a sounder, and a transmitter and receiver, the base station comprising:
a housing;
a transmitter within the housing for communicating with the at least one smoke alarm;
means for causing the transmitter to transmit a test signal including the serial number, and
a plurality of pins extending from the housing, the pins and housing cooperating to define a unitary plug for connection to an electrical supply socket, so that the base station is supported by the pins when the plug is inserted into an electrical supply socket.

10. A base station according to claim 9 further comprising means for causing the transmitter to transmit a learn signal including a serial number of the base station

11. A base station according to claim 9 or 10 wherein the transmitter is a transceiver for both transmitting and receiving.

12. A base station according to claim 9, 10 or 11 further comprising a means for causing the base station to transmit a panic message to the smoke alarms to cause them to sound an alarm.

13. A base station according to any of claims 9 to 12 further comprising a means for causing the base station to transmit a test signal is a test/mute control, arranged to broadcast a message to all smoke alarms of the system on operation of the test control to mute the smoke alarms if any of the smoke alarms of the system are active and otherwise to test the smoke alarms of the system.

14. A base station according to any of claims 9 to 12 wherein the means for causing the base station to transmit a test signal is a test control and the base station further includes a mute control, wherein the base station is arranged:
to broadcast a message to all smoke alarms of the system on operation of the test control to test the smoke alarms of the system;
to broadcast a message to all smoke alarms of the system on operation of the mute control to mute the smoke alarms; and
on operation of the test and mute controls in the correct predetermined sequence to cause the base station to transmit a panic message to the other units to cause the other units to sound an alarm.

15. A method of operating a smoke alarm system including at least one smoke alarm unit and at least one base unit, comprising:
plugging at least one base unit having at least one control into a respective electrical power socket to be supported by the socket;
operating a control on the base unit;
transmitting a message corresponding to the operated control to the other units to test, silence, or sound the sounders of the units of the smoke alarm system.

16. A method according to claim 15, further comprising
operating at least one control on a base unit to indicate a panic situation;
sending a “panic” message from the base unit to the other units; and
sounding an alarm in the other units on receipt of the “panic” message.

17. A method according to claim 15 or 16 further comprising:
actuating a test/mute control on a base unit;
if any smoke alarms are sounding, to control the smoke alarm units by sending a “silence” message to the other units to silence any sounding smoke alarms of the system; and
if no smoke alarms are sounding, to send a “test” message to the actuate a test mode to test the smoke alarm system.

18. A method according to claim 15 or 16 further comprising:
actuating a test control on a base unit and sending a “test” message to the actuate a test mode to test the smoke alarm system.

19. A method according to claim 15 or 18 further comprising:
actuating a mute control on a base unit and sending a “silence” message to the other units to silence any sounding smoke alarms of the system.

20. A method according to any of claims 15 to 19 wherein the smoke alarm and base units include a system address value unit setting a system address value in common for the system, the method further comprising transmitting broadcast messages including the system address value and a message type value, the message type value indicating one of a plurality of messages including a smoke alarm mute message, a test message, and a smoke alarm message, the messages being broadcast to all other units of the system.
